(19) United States
(12) Patent Application Publication
(10) Pub. No.: US 2025/0117953 A1
(43) Pub. Date: Apr. 10, 2025

(54) LIVE CO-REGISTRATION OF EXTRAVASCULAR AND INTRAVASCULAR IMAGING

(71) Applicant: Boston Scientific Scimed, Inc., Maple Grove, MN (US)

(72) Inventors: Yan Li, Plymouth, MN (US); Hatice Cinar Akakin, Eden Prairie, MN (US); Erik Stephen Freed, Maple Grove, MN (US); Kevin Bloms, Minneapplolis, MN (US); Wenguang Li, Los Gatos, CA (US)

(73) Assignee: Boston Scientific Scimed, Inc., Maple Grove, MN (US)

(21) Appl. No.: 18/904,130

(22) Filed: Oct. 2, 2024

Related U.S. Application Data
(60) Provisional application No. 63/588,559, filed on Oct. 6, 2023.

(51) Int. Cl. G06T 7/33

(52) U.S. Cl. CPC G06T 7/337; G06T 2207/10064; G06T 2207/10132; G06T 2207/20081; G06T 2207/30021; G06T 2207/30048; G06T 2207/30101; G06T 2207/30172

(57) ABSTRACT

The present disclosure provides to co-register intravascular images of a vessel with one or more extravascular images of the vessel in real-time, such as, during acquisition of the extravascular images. Key points in a first frame of the extravascular images can be identified and then tracked across other frames of the extravascular images. The intravascular images can be co-registered to a frame (or frames) of the extravascular images based on the locations of the key points in the frame.

### CROSS-REFERENCE TO RELATED APPLICATIONS

This application claims the benefit of U.S. Provisional Patent Application Ser. No. 63/588,559 filed on Oct. 6, 2023, the disclosure of which is incorporated herein by reference.

### TECHNICAL FIELD

The present disclosure pertains to angiography and intravascular imaging modalities and to co-registration of angiography images with intravascular imaging modalities.

### BACKGROUND

Ultrasound devices insertable into a patient's vasculature have proven diagnostic capabilities for a variety of diseases and disorders. For example, intravascular ultrasound (IVUS) imaging systems have been used as an intravascular imaging modality for diagnosing blocked blood vessels and providing information to aid medical practitioners in selecting and placing stents, selecting sites for an atherectomy procedure, or the like.

IVUS imaging systems includes a control module (with a pulse generator, an image acquisition and processing components, and a monitor), a catheter, and a transducer disposed in the catheter. The transducer-containing catheter is positioned in a lumen or cavity within, or in proximity to, a region to be imaged, such as a blood vessel wall or patient tissue in proximity to a blood vessel wall. The pulse generator in the control module generates electrical pulses that are delivered to the transducer and transformed to acoustic pulses that are transmitted through patient tissue. The patient tissue (or other structure) reflects the acoustic pulses and reflected pulses are absorbed by the transducer and transformed to electric pulses. The transformed electric pulses are delivered to the image acquisition and processing components and converted into images displayable on the monitor.

CT coronary angiography (CTA or CCTA) is the use of CT angiography to assess the coronary arteries of the heart via an extravascular image. Typically, a patient receives an intravenous injection of contrast agent and then the heart is scanned using a high speed CT scanner. CTA and IVUS are often used in conjunction with each other. For example, a physician will use the CTA and the IVUS to assess the extent of an occlusion (or occlusions) in the coronary arteries, usually to diagnose coronary artery disease.

To aid physicians in reviewing these images, they are often co-registered to each other. For example, each image in a series of IVUS images can be mapped, or co-located, to a position of the vessel represented in the CTA image.

Co-registration of angiography and IVUS images is a transformative technique that enhances the assessment of coronary artery disease by offering a comprehensive understanding of plaque composition, severity, and vessel anatomy. This advancement significantly improves the precision of stent placement, treatment strategizing, and lesion monitoring.

Thus, there is a need for improved co-registration techniques and workflows.

### BRIEF SUMMARY

The present disclosure provides a system configured to co-register angiography and IVUS images “live” or in “real-time.” Conventionally, co-registration workflows operate in an “off-line” fashion wherein co-registration takes places after the imaging procedures are completed. Accordingly, the present disclosure provides an advantage over conventional systems, in that the present disclosure can be implemented in a system to provide real-time insights during medical procedures, thereby empowering clinicians to observe dynamic changes in vessel anatomy, plaque characteristics, and stent deployment. Further, the present disclosure provides immediate feedback to a physician, thereby offering better on-the-spot decision-making and the ability to make real-time adjustments to the procedure for optimized outcomes.

With some embodiments, the disclosure can be implemented as a method for identifying side branches from an image. The method can comprise receiving, at a computing device, a plurality of extravascular image frames associated with a vessel of a patient; identifying, by the computing device, locations of key points in a first frame of the plurality extravascular image frames; identifying, by the computing device, locations of the key points in a second frame of the plurality of extravascular image frames based in part on the locations of the key points in the first frame; and co-registering a plurality of intravascular image frames with the first frame based in part on the locations of the key points in the first frame; or co-registering the plurality of intravascular image frames with the second frame based in part on the locations of the key points in the second frame; or co-registering a plurality of intravascular image frames with the first frame based in part on the locations of the key points in the first frame and co-registering the plurality of intravascular image frames with the second frame based in part on the locations of the key points in the second frame.

In further embodiments, the method can comprise generating, by the computing device, a first graphical indication of the first frame co-registered with the plurality of intravascular image frames and a second graphical indication of the second frame co-registered with the plurality of intravascular image frames; and sending the first graphical indication and the second graphical indication to a display device to display the co-registered plurality of intravascular images in synchronization with a cardiac motion associated with the plurality of extravascular image frames.

In further embodiments of the method, the plurality of image frames are image frames from a cine loop captured during a fluoroscopy procedure.

In further embodiments of the method, the plurality of intravascular image frames are intravascular ultrasound (IVUS) image frames.

In further embodiments, the method can comprise receiving, at the computing device, an additional extravascular image frame; identifying, by the computing device, locations of the key points in the additional extravascular frame based in part on the locations of the key points in the second frame; and co-registering the plurality of intravascular image frames with the additional extravascular image frame based in part on the locations of the key points in the additional extravascular image frame.

In further embodiments of the method, receiving the additional extravascular image frame comprises receiving the additional extravascular image frame during an extravascular imaging procedure.

In further embodiments of the method, identifying the locations of the key points in the first frame comprises: identifying, by the computing device, catheter locations in the first frame; identifying, by the computing device, a centerline of the vessel in the first frame based in part on the at catheter locations; and identifying, by the computing device, locations of side branches of the vessel along the centerline.

In further embodiments of the method, identifying the catheter locations in the first frame comprises: inferring, by the computing device using a tip identification machine learning (ML) model, a location of a tip of an imaging catheter in the first frame; or receiving, at the computing device from an input device coupled to the computing device, an indication of the location of the tip of the imaging catheter in the first frame.

In further embodiments of the method, identifying the catheter locations in the first frame further comprises inferring, by the computing device using an entry point identification ML model, a location of an entry point of the guide catheter in the first frame.

In further embodiments of the method, co-registering the plurality of intravascular image frames with the first frame based in part on the locations of the key points in the first frame comprises receiving, at the computing device, the plurality of intravascular image frames; identifying, by the computing device, a subset of frames of the plurality of intravascular image frames associated with a side branch; mapping, by the computing device, the plurality of intravascular image frames onto the centerline based in part on the subset of frames of the plurality of intravascular image frames associated with the side branch; matching, by the computing device, the side branches associated with the first frame with the side branches associated with the subset of frames of the plurality of intravascular image frames; and adjusting, by the computing device, locations of the side branches associated with the subset of frames based in part on the matching.

In further embodiments of the method, identifying the locations of the key points in the second frame of the plurality of extravascular image frames based in part on the locations of the key points in the first frame comprises tracking, by the computing device, the catheter locations between the first frame and the second frame; tracking, by the computing device, the locations of the side branches of the vessel between the first frame and the second frame; and identifying, by the computing device, the centerline of the vessel in the second frame based in part on the locations of the tip of the guide catheter, the entry point of the guide catheter, and the side branches.

In further embodiments of the method, identifying the locations of the key points in the first frame further comprises inferring, by the computing device using the tip identification ML model, a location of the tip of the guide catheter in each of the plurality of extravascular image frames, wherein a confidence value, for each inference of the location of the tip of the guide catheter, is output from the tip identification ML model; selecting, by the computing device, the first frame as the one of the plurality of extravascular image frames associated with the highest confidence value.

In further embodiments of the method, identifying the locations of the key points in the first frame further comprises identifying, by the computing device, a contrast for each of the plurality of extravascular image frames; and selecting, by the computing device, the first frame as the one of the plurality of extravascular image frames having the viable image quality.

With some embodiments, the disclosure can be implemented as a computer-readable storage device. The computer-readable storage device can comprise instructions executable by a processor of a computing device coupled to an intravascular imaging device and a fluoroscope device, wherein when executed the instructions cause the computing device to implement any of the methods disclosed herein.

With some embodiments, the disclosure can be implemented as an apparatus comprising a processor arranged to be coupled to an intravascular imaging device and a fluoroscope device. The apparatus can further comprise a memory comprising instructions, the processor arranged to execute the instructions to implement the any of the methods disclosed herein.

With some embodiments, the disclosure can be implemented as an apparatus for a cross-modality side branch matching system. The apparatus can comprise a processor and a memory storage device coupled to the processor, the memory storage device comprising instructions executable by the processor, which instructions when executed cause the apparatus to receive a plurality of extravascular image frames associated with a vessel of a patient; identify locations of key points in a first frame of the plurality extravascular image frames; identify locations of the key points in a second frame of the plurality of extravascular image frames based in part on the locations of the key points in the first frame; and co-register a plurality of intravascular image frames with the first frame based in part on the locations of the key points in the first frame; or co-register the plurality of intravascular image frames with the second frame based in part on the locations of the key points in the second frame; or co-register a plurality of intravascular image frames with the first frame based in part on the locations of the key points in the first frame and co-registering the plurality of intravascular image frames with the second frame based in part on the locations of the key points in the second frame.

In further embodiments of the apparatus, the instructions when executed further cause the apparatus to generate a first graphical indication of the first frame co-registered with the plurality of intravascular image frames and a second graphical indication of the second frame co-registered with the plurality of intravascular image frames; and send the first graphical indication and the second graphical indication to a display device to display the co-registered plurality of intravascular images in synchronization with a cardiac motion associated with the plurality of extravascular image frames.

In further embodiments of the apparatus, the plurality of image frames are image frames from a cine loop captured during a fluoroscopy procedure.

In further embodiments of the apparatus, the plurality of intravascular image frames are intravascular ultrasound (IVUS) image frames.

In further embodiments of the apparatus, instructions when executed further cause the apparatus to receive an additional extravascular image frame; identify locations of the key points in the additional extravascular frame based in part on the locations of the key points in the second frame; and co-register the plurality of intravascular image frames with the additional extravascular image frame based in part on the locations of the key points in the additional extravascular image frame.

In further embodiments of the apparatus, the instructions when executed to receive the additional extravascular image frame further causes the apparatus to receive the additional extravascular image frame during an extravascular imaging procedure.

In further embodiments of the apparatus, the instructions when executed to identify the locations of the key points in the first frame further causes the apparatus to identify catheter locations in the first frame; identify a centerline of the vessel in the first frame based in part on the at catheter locations; and identify locations of side branches of the vessel along the centerline.

In further embodiments of the apparatus, the instructions when executed to identify the catheter locations in the first frame further causes the apparatus to infer, using a tip identification machine learning (ML) model, a location of a tip of an imaging catheter in the first frame; or receive, from an input device coupled to the computing device, an indication of the location of the tip of the imaging catheter in the first frame.

In further embodiments of the apparatus, the instructions when executed to identify the catheter locations in the first frame further causes the apparatus to infer, using an entry point identification ML model, a location of an entry point of the guide catheter in the first frame.

In further embodiments of the apparatus, the instructions when executed to co-register the plurality of intravascular image frames with the first frame based in part on the locations of the key points in the first frame further causes the apparatus to receive the plurality of intravascular image frames; identify a subset of frames of the plurality of intravascular image frames associated with a side branch; map the plurality of intravascular image frames onto the centerline based in part on the subset of frames of the plurality of intravascular image frames associated with the side branch; match the side branches associated with the first frame with the side branches associated with the subset of frames of the plurality of intravascular image frames; and adjust locations of the side branches associated with the subset of frames based in part on the matching.

In further embodiments of the apparatus, the instructions when executed to identify the locations of the key points in the second frame of the plurality of extravascular image frames based in part on the locations of the key points in the first frame further causes the apparatus to track the catheter locations between the first frame and the second frame; track the locations of the side branches of the vessel between the first frame and the second frame; and identify the centerline of the vessel in the second frame based in part on the locations of the tip of the guide catheter, the entry point of the guide catheter, and the side branches.

In further embodiments of the apparatus, the instructions when executed to identify the locations of the key points in the first frame further causes the apparatus to infer using the tip identification ML model, a location of the tip of the guide catheter in each of the plurality of extravascular image frames, wherein a confidence value, for each inference of the location of the tip of the guide catheter, is output from the tip identification ML model; select the first frame as the one of the plurality of extravascular image frames associated with the highest confidence value.

In further embodiments of the apparatus, the instructions when executed to identify the locations of the key points in the first frame further causes the apparatus to identify a contrast for each of the plurality of extravascular image frames; and select the first frame as the one of the plurality of extravascular image frames having the viable image quality.

With some embodiments, the disclosure can be implemented as a computer-readable storage device. The computer-readable storage device can comprise instructions executable by a processor of a cross-modality side branch matching system, wherein when executed the instructions cause the processor to receive a plurality of extravascular image frames associated with a vessel of a patient; identify locations of key points in a first frame of the plurality extravascular image frames; identify locations of the key points in a second frame of the plurality of extravascular image frames based in part on the locations of the key points in the first frame; and co-register a plurality of intravascular image frames with the first frame based in part on the locations of the key points in the first frame; or co-register the plurality of intravascular image frames with the second frame based in part on the locations of the key points in the second frame; or co-register a plurality of intravascular image frames with the first frame based in part on the locations of the key points in the first frame and co-registering the plurality of intravascular image frames with the second frame based in part on the locations of the key points in the second frame.

In further embodiments of the computer-readable storage device, the instructions when executed further cause the processor to generate a first graphical indication of the first frame co-registered with the plurality of intravascular image frames and a second graphical indication of the second frame co-registered with the plurality of intravascular image frames; and send the first graphical indication and the second graphical indication to a display device to display the co-registered plurality of intravascular images in synchronization with a cardiac motion associated with the plurality of extravascular image frames.

In further embodiments of the computer-readable storage device, the plurality of image frames are image frames from a cine loop captured during a fluoroscopy procedure.

In further embodiments of the computer-readable storage device, the plurality of intravascular image frames are intravascular ultrasound (IVUS) image frames.

In further embodiments of the computer-readable storage device, the instructions when executed further cause the processor to receive an additional extravascular image frame; identify locations of the key points in the additional extravascular frame based in part on the locations of the key points in the second frame; and co-register the plurality of intravascular image frames with the additional extravascular image frame based in part on the locations of the key points in the additional extravascular image frame.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1A and FIG. 1B illustrate a live co-registration system in accordance with at least one embodiment.

FIG. 2 illustrates a routine for co-registering IVUS images with angiography images in real-time, in accordance with at least one embodiment.

FIG. 3 illustrates a routine for identifying key points in an initial angiography image frame, in accordance with at least one embodiment.

FIG. 4 illustrates a routine for identifying key points in a subsequent angiography image frame, in accordance with at least one embodiment.

FIG. 5 illustrates a routine for co-registering IVUS image frames with an angiography image frame based on key points, in accordance with at least one embodiment.

FIG. 6A and FIG. 6B illustrate an example angiography image frame and identification of key points and a vessel centerline, in accordance with at least one embodiment.

FIG. 7A, FIG. 7B, and FIG. 7C illustrate an example series of angiography image frames and identification of key points and a vessel centerline, in accordance with at least one embodiment.

FIG. 8A and FIG. 8B illustrate exemplary artificial intelligence/machine learning (AI/ML) systems suitable for use with at least one embodiment.

FIG. 9 illustrates a computer-readable storage medium in accordance with at least one embodiment.

FIG. 10 illustrates an example vascular imaging system, in accordance with at least one embodiment.

FIG. 11 illustrates a diagrammatic representation of a machine in the form of a computer system within which a set of instructions may be executed for causing the machine to perform any one or more of the methodologies discussed herein, according to an example embodiment.

### DETAILED DESCRIPTION

As noted above, the present disclosure provides methods and apparatuses for real-time or live co-registration of angiography and IVUS images. It is noted that although the present disclosure uses examples and described techniques with reference to angiography and IVUS, any suitable extravascular imaging modality and intravascular imaging modality can be utilized. That is, the present disclosure is directed to live co-registration of extra-luminal and intra-luminal imaging modalities and not to the specific imaging modalities themselves.

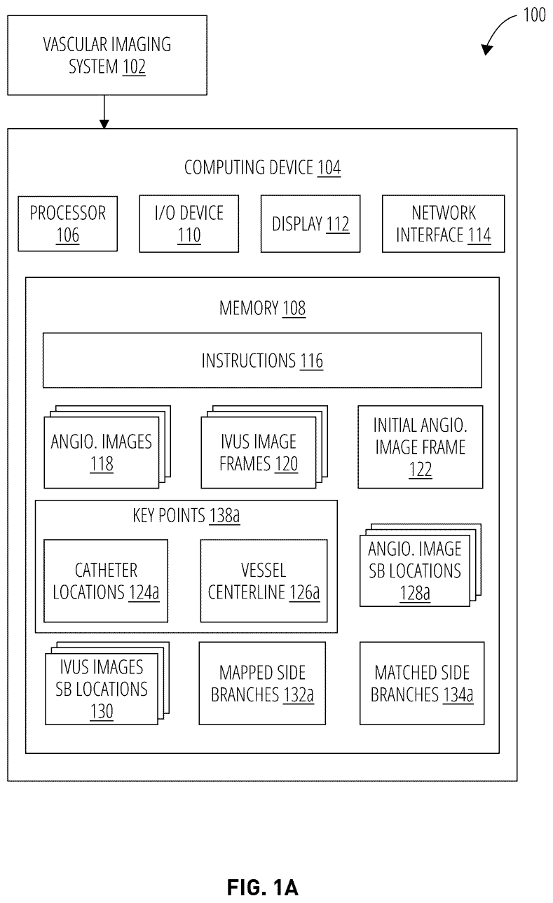

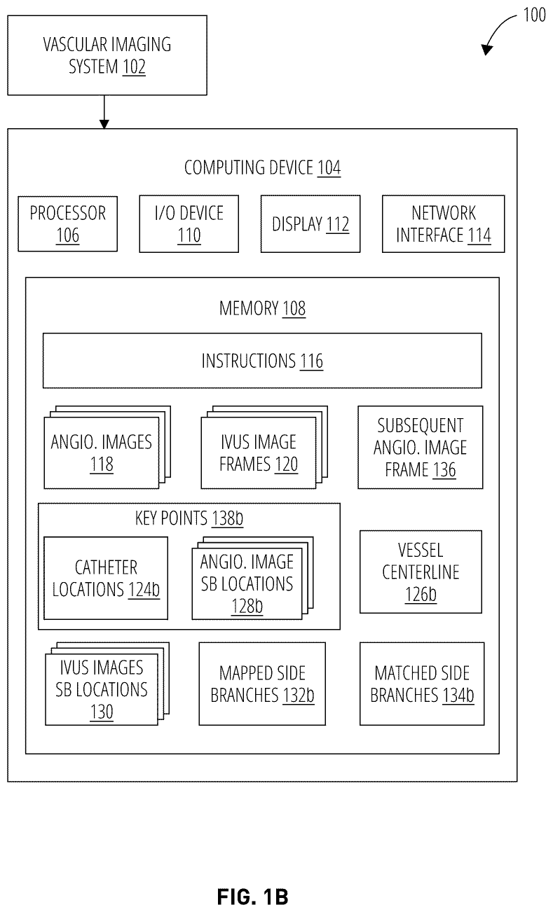

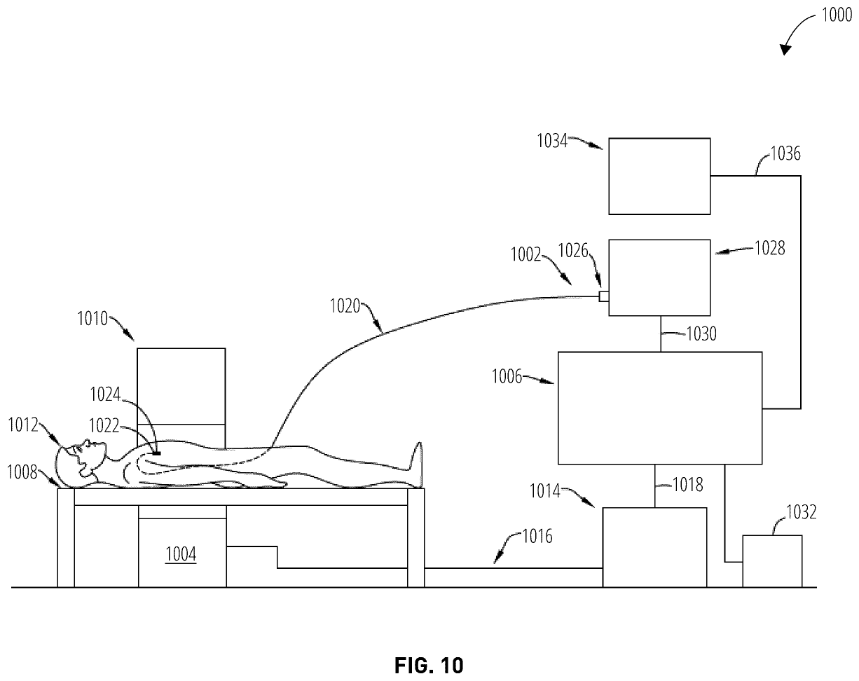

FIG. 1A and FIG. 1B illustrate a live co-registration system 100, in accordance with an embodiment of the present disclosure. In general, live co-registration system 100 is a system configured to co-register images of a vessel captured using different imaging modalities in real-time (e.g., during image acquisition, or the like). For example, live co-registration system 100 can be configured to co-register angiography image frames 118 and IVUS image frames 120. To that end, live co-registration system 100 includes, or can be coupled to, vascular imaging system 102. Vascular imaging system 102 can be any of a variety of vascular imaging systems configured to capture images from multiple imaging modalities (e.g., angiography, IVUS, intravascular OCT, or the like). An example of a vascular imager configured to capture both external (angiography) and internal (IVUS) vascular images is described with reference to the combined internal and external imaging system 1000 depicted in FIG. 10.

Live co-registration system 100 includes computing device 104. Computing device 104 can be any of a variety of computing devices. In some embodiments, computing device 104 can be incorporated into and/or implemented by a console of vascular imaging system 102. With some embodiments, computing device 104 can be a tablet, laptop, workstation, or server communicatively coupled to vascular imaging system 102. With still other embodiments, computing device 104 can be provided by a cloud based computing device, such as, by a Computing as a Service (CaaS) system accessibly over a network (e.g., the Internet, an intranet, a wide area network, or the like). Computing device 104 can include processor 106, memory 108, input and/or output (I/O) device 110, and network interface 114.

The processor 106 may include circuity or processor logic, such as, for example, any of a variety of commercial processors. In some examples, processor 106 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 106 may include graphics processing portions and may include dedicated memory, multiple-threaded processing and/or some other parallel processing capability. In some examples, the processor 106 may be an application specific integrated circuit (ASIC) or a field programmable integrated circuit (FPGA).

The memory 108 may include logic, a portion of which includes arrays of integrated circuits, forming non-volatile memory to persistently store data or a combination of non-volatile memory and volatile memory. It is to be appreciated, that the memory 108 may be based on any of a variety of technologies. In particular, the arrays of integrated circuits included in memory 108 may be arranged to form one or more types of memory, such as, for example, dynamic random access memory (DRAM), NAND memory, NOR memory, or the like.

I/O devices 110 can be any of a variety of devices to receive input and/or provide output. For example, I/O devices 110 can include, a keyboard, a mouse, a joystick, a foot pedal, a haptic feedback device, an LED, or the like. Display 112 can be a conventional display or a touch-enabled display. Further, display 112 can utilize a variety of display technologies, such as, liquid crystal display (LCD), light emitting diode (LED), or organic light emitting diode (OLED), or the like.

Network interface 114 can include logic and/or features to support a communication interface. For example, network interface 114 may include one or more interfaces that operate according to various communication protocols or standards to communicate over direct or network communication links. Direct communications may occur via use of communication protocols or standards described in one or more industry standards (including progenies and variants). For example, network interface 114 may facilitate communication over a bus, such as, for example, peripheral component interconnect express (PCle), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 114 can include logic and/or features to enable communication over a variety of wired or wireless network standards (e.g., 802.11 communication standards). For example, network interface 114 may be arranged to support wired communication protocols or standards, such as, Ethernet, or the like. As another example, network interface 114 may be arranged to support wireless communication protocols or standards, such as, for example, Wi-Fi, Bluetooth, ZigBee, LTE, 5G, or the like.

Memory 108 can include instructions 116, angiography image frames 118, IVUS image frames 120, initial angiography image frame 122, catheter locations 124a and 124b, vessel centerlines 126a and 126b, angiography image side branch locations 128a and angiography image side branch locations 128b, IVUS images side branch locations 130, mapped side branches 132a and 132b, matched side branches 134a and 134b, subsequent angiography image frame 136, and key points 138a and key points 138b.

During operation, processor 106 can execute instructions 116 to cause computing device 104 to receive IVUS image frames 120 and initial angiography image frame 122 from vascular imaging system 102. In general, angiography image frames 118 can be a series of angiography images, also referred to as angiograms, (e.g., cine-loop, or the like) that can be CT images of a patient's heart (or portion of a patient's heart) captured after injection of a contrast agent into the patient's vasculature. Similarly, IVUS image frames 120 can be series of ultrasound images captured from within a vessel of the patient's heart as an ultrasound probe is pulled back through a portion of the vessel. With some embodiments, angiography image frames 118 can be captured while IVUS image frames 120 is captured. In other embodiments, IVUS image frames 120 can be captured and then angiography image frames 118 can be captured and the live co-registration system 100 can be configured to co-register angiography image frames 118 with IVUS image frames 120 in real-time while angiography image frames 118 are being captured. In some embodiments, angiography image frames 118 can be captured and then IVUS image frames 120 can be captured. For example, processor 106 can execute instructions 116 to cause computing device 104 to utilize a previously captured angiography image frame as angiography image frame 118.

It is noted that the present disclosure provides to co-register IVUS image frames 120 to one (or each) frame of angiography image frames 118 in “real-time” (e.g., as angiography image frames 118 is captured). As such, there will necessarily be a first co-registered frame and there can be subsequent co-registered frames. For example, in some embodiments, co-registration may start after a few (e.g., 2, 3, 4, 5, etc.) frames of angiography image frames 118 have been captured and can continue to co-register IVUS image frames 120 to subsequently captured frames as they are captured. To that end, processor 106 can execute instructions 116 to cause computing device 104 to select an image frame from the angiography image frames 118 to initiate the “live” co-registration. In some embodiments, processor 106 can execute instructions 116 to select the frame from the angiography image frames 118 having a viable image quality as the initial angiography image frame 122. FIG. 1A depicts the live co-registration system 100 co-registering IVUS image frames 120 to an initial frame (e.g., initial angiography image frame 122) of angiography image frames 118 while FIG. 1B depicts the live co-registration system 100 co-registering a subsequent frame (e.g., subsequent angiography image frame 136) of angiography image frames 118. As used herein, term “viable” can mean the image with the least cross-over vessel, the best contrast, the most visible guide catheter entry and catheter tip, or the like.

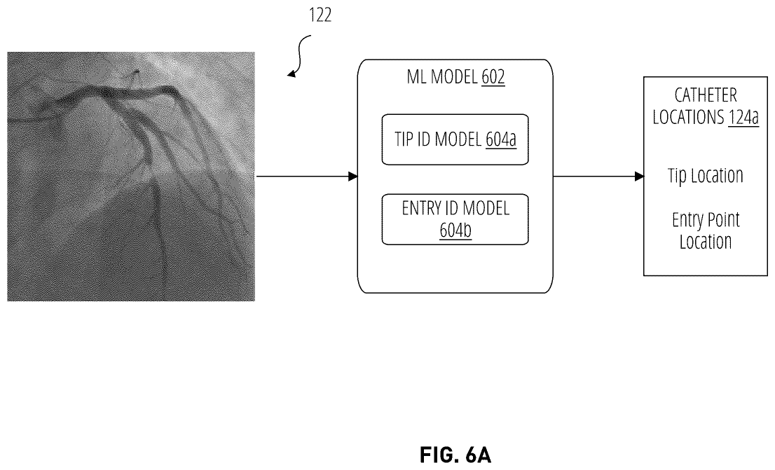

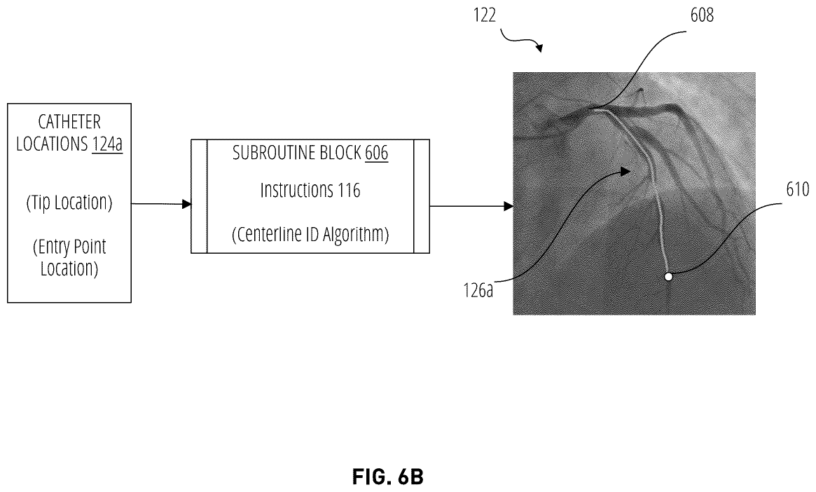

Processor 106 can further execute instructions 116 to cause computing device 104 to identify catheter locations 124a. In general, catheter locations 124a indicate both the location of (1) the entry of the guide catheter used to introduce the imaging catheter with which the IVUS image frames 120 are captured as well and (2) the tip of the imaging catheter in the initial angiography image frame 122 (refer to FIG. 6A and FIG. 6B). With some embodiments, processor 106 can execute instructions 116 to infer catheter locations 124a using a machine learning (ML) model trained to identify a location of a guide catheter entry and/or imaging catheter tip from angiography image frames. In such an example, some embodiments of the disclosure may provide that processor 106 is configured to infer catheter locations 124a from each frame of angiography image frames 118 and select the frame with the highest confidence of identification of the catheter locations 124a (e.g., as determined by the ML model, or the like) as the initial angiography image frame 122.

In some embodiments, a first ML model can be trained and used to infer the location of the tip of the imaging catheter from angiography image frames 118 while a second ML model can be trained and used to infer the location of the guide catheter entry. In alternative embodiments of the disclosure, processor 106 can execute instructions 116 to receive (e.g., from a user, or the like) an indication of one component of catheter locations 124a. For example, processor 106 can execute instructions 116 to receive an indication of the tip of the imaging catheter via I/O device 110 (or the like).

Processor 106 can further execute instructions 116 to identify a vessel centerline 126a from the initial angiography image frame 122 using the catheter locations 124a. It is noted that a variety of techniques are available to identify a centerline of a vessel from an angiography image. The present disclosure can be implemented with any of these various techniques to identify vessel centerline 126a from initial angiography image frame 122 and catheter locations 124a.

Once processor 106 executes 116 to identify vessel centerline 126a, processor 106 can execute instructions 116 to identify angiography image side branch locations 128a defined with respect to the initial angiography image frame 122. Further, processor 106 can execute instructions 116 to identify other fiducials (e.g., guide catheter entry point, imaging catheter tip locations, etc.) Additionally, processor 106 can execute instructions 116 to identify 130 from IVUS image frames 120. It is noted that a variety of techniques are available to identify side branches in an angiography image or IVUS images. The present disclosure can be implemented with any of these various techniques to identify angiography image side branch locations 128a from angiography image frames 118 and vessel centerline 126a and IVUS images side branch locations 130 from IVUS image frames 120.

Processor 106 can further execute instructions 116 to map the angiography image side branch locations 128a and IVUS images side branch locations 130 onto the vessel centerline 126a of the initial angiography image frame 122, resulting in mapped side branches 132a. Further, processor 106 can execute instructions 116 to match ones of angiography image side branch locations 128a to respective ones of IVUS images side branch locations 130, resulting in matched side branches 134a.

Once IVUS image frames 120 are co-registered to an initial frame (e.g., initial angiography image frame 122) of angiography image frames 118, processor 106 can execute instructions 116 to co-register IVUS image frames 120 with other frames of angiography image frames 118. For example, FIG. 1B illustrates live co-registration system 100 with subsequent angiography image frame 136 stored in memory 108. It is noted that initial angiography image frame 122 and subsequent angiography image frame 136 may not be separately stored in memory 108 as depicted, but instead, processor 106 may execute display 112 to flag or designates ones of angiography image frames 118 as initial angiography image frame 122 or subsequent angiography image frame 136. However, these frames are depicted separately from angiography image frames 118 in the figures for clarity of presentation and for ease of referring to individual frames (e.g., frame N, frame N+1, etc.) of angiography image frames 118 along with the identified side branches and key points.

Processor 106 can execute instructions 116 to identify “key points” for subsequent angiography image frame 136 from “key points” of initial angiography image frame 122. In general, key points 138b can include any fiducial. In the embodiment depicts in FIG. 1A and FIG. 1B, key points 138b include side branches, and guide catheter entry location, and imaging catheter tip For example, key points 138a includes catheter locations 124a and angiography image side branch locations 128a while key points 138b includes catheter locations 124b, and angiography image side branch locations 128b. In general, key points 138a from an initial frame (e.g., frame N) are used to identify key points 138b for a subsequent frame (e.g., frame N>1). For example, processor 106 can execute instructions 116 to identify key points 138b (e.g., catheter locations 124b and angiography image side branch locations 128b) for subsequent angiography image frame 136 from key points 138a (e.g., catheter locations 124a and angiography image side branch locations 128a).

It is to be appreciated that due to foreshortening and two-dimensional (2D) domain limitations of three-dimensional (3D) tissue structures (e.g., the vessel in angiography image frames 118 and IVUS image frames 120), most visible key-points will be detected for each frame in angiography image frames 118. In some embodiments, processor 106 can execute instructions 116 to identify key points 138b from angiography image side branch locations 128a using a point tracking algorithm (e.g., multiple object tracking algorithms, a simple online real-time (SORT) tracking algorithm, a joint detection and embedding (JDE) algorithm). In some embodiments, an ML model (e.g., single shot detector, or the like) can be trained to track key points across angiography image frames and can be used to infer key points 138b from key points 138a.

Processor 106 can execute instructions 116 to identify vessel centerline 126b for subsequent angiography image frame 136 from guide catheter entry location 124b and imaging catheter tip and subsequent angiography image frame 136. Further embodiments, processor 106 can execute instructions 116 to identify vessel centerline 126b for subsequent angiography image frame 136 from catheter locations 124b (e.g., guide catheter entry and imaging catheter tip locations) and angiography image side branch locations 128b, thereby enhancing the precision of the identified centerline. With some embodiments, processor 106 can execute instructions 116 to identify vessel centerline 126b from either just catheter locations 124b (e.g., guide catheter entry and imaging catheter tip locations) or from both catheter locations 124b and angiography image side branch locations 128b. For example, in instances where one or more locations in catheter locations 124b cannot be reliably (e.g., with a threshold confidence, or the like) identified, processor 106 can execute instructions 116 to identify vessel centerline 126b from angiography image side branch locations 128b. Further, processor 106 can execute instructions 116 to identify the vessel centerline 126b from a catheter location that is identifiable (e.g., guide catheter entry or imaging catheter tip) and the angiography image side branch locations 128b.

Processor 106 can further execute instructions 116 to map the angiography image side branch locations 128b and IVUS images side branch locations 130 onto the vessel centerline 126b of the subsequent angiography image frame 136, resulting in mapped side branches 132b. Further, processor 106 can execute instructions 116 to match ones of angiography image side branch locations 128b to respective ones of IVUS images side branch locations 130, resulting in matched side branches 134b.

Accordingly, the present disclosure provides a technique that enables real-time co-registration of IVUS, and angiography images based on the dynamic tracking of catheter pullback paths, the identification of angiography side branches within the angiography loop, and the precise alignment of IVUS side branches with the identified angiography side branches. This provides a significant advantage and improvement to current co-registration technology.

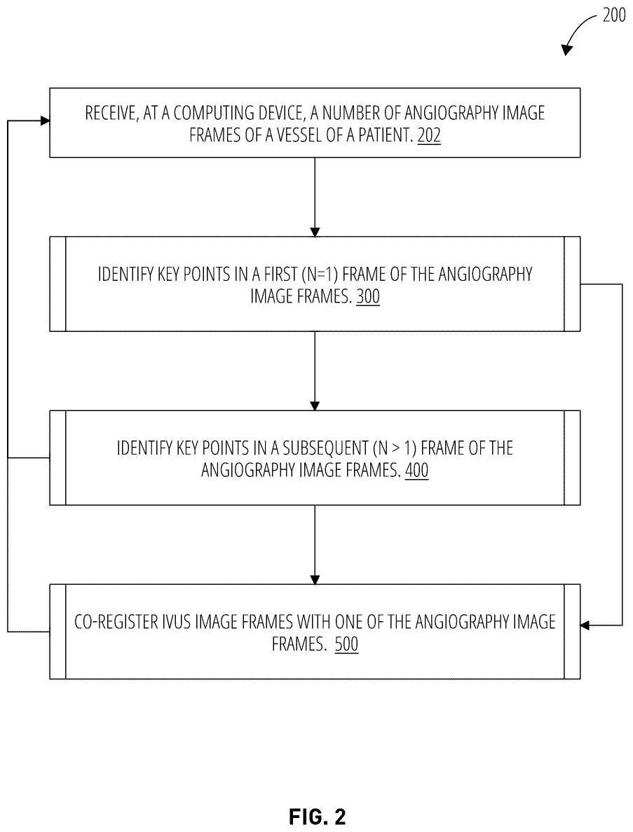

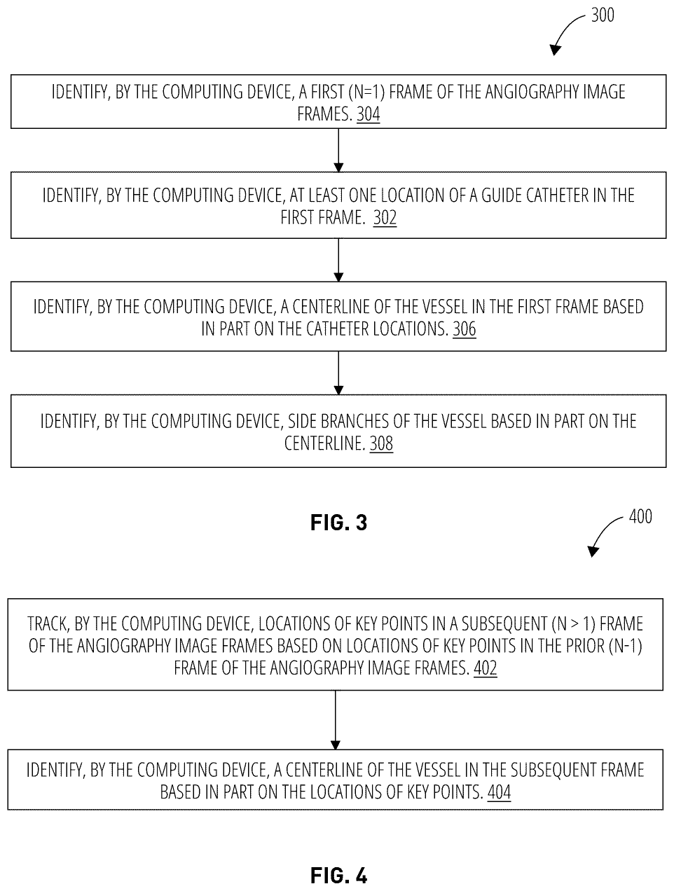

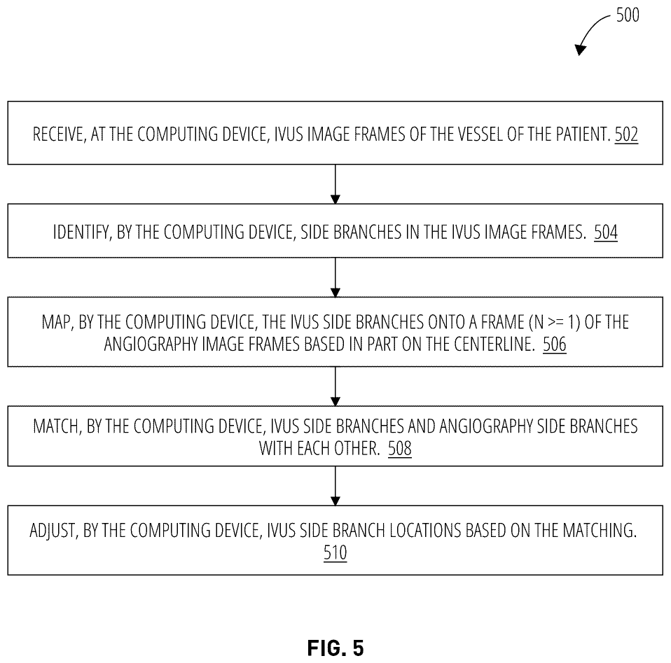

FIG. 2, FIG. 3, FIG. 4, and FIG. 5 illustrate routines 200, 300, 400, and 500 respectively, according to some embodiments of the present disclosure. Routine 200 can be implemented by live co-registration system 100, or another computing device, as outlined herein to co-register IVUS and angiography images in real-time. For example, routine 200 can be implemented to co-register IVUS image frames 120 with a frame of angiography image frames 118 in real-time (e.g., while angiography image frames 118 are being captures, or the like). Routine 200 can include routines 300, 400, and 500 as described more fully below.

Routine 200 can begin at block 202 “receive, at a computing device, a number of angiography image frames of a vessel of a patient” angiography image frames can be received at a computing device. For example, computing device 104 of live co-registration system 100 can receive angiography image frames 118 (e.g., from vascular imaging system 102, or the like).

Routine 200 can continue from block 202 to routine 300 where key points in a first (e.g., N=1) frame of the angiography image frames can be identified. For example, processor 106 can execute instructions 116 to identify key points 138a from initial angiography image frame 122 as outlined by routine 300.

Routine 200 can continue to either routine 400 or routine 500 from routine 300. For example, routine 200 can continue from routine 300 to routine 400 to prep a subsequent (e.g., N>1) frame of the angiography image frames for co-registration. In another example, routine 200 can continue from routine 300 to routine 500 to co-register IVUS image frames with the first (e.g., N=1) angiography image frame.

From routine 400, routine 200 can continue to either routine 500 or return to block 202. For example, routine 200 can continue from routine 400 to routine 500 to co-register IVUS image frames with a subsequent (e.g., N>1) angiography image frame. Likewise, routine 200 can continue from routine 500 to block 202. Routine 200 can return to block 202 from either routine 400 or routine 500 to receive additional angiography image frames (e.g., capture more frames in the cine-loop, or the like).

FIG. 3 illustrates routine 300, which can begin at block 302. At block 302 “identify, by the computing device, a first (N=1) frame of the angiography image frames” an initial frame or “first” frame of the angiography image frames is identified. For example, computing device 104 can identify a frame of the angiography image frames 118 to use as the initial angiography image frame 122. Processor 106 can execute instructions 116 to determine or select initial angiography image frame 122 from angiography image frames 118, for example, based on the image quality of each frame.

In other embodiments, processor 106 can execute instructions 116 to identify the first frame in conjunction with identifying a guide catheter tip. For example, routine 300 can continue from block 302 to block 304. At block 304 “identify, by the computing device, at least one location of a guide catheter in the first frame” a location of a guide catheter (e.g., IVUS guide catheter, or the like) can be identified. With some embodiments, both a tip of the imaging catheter and entry point of the guide catheter can be identified. For example, computing device 104 can be configured to identify catheter locations 124a and imaging catheter tip from initial angiography image frame 122.

In some examples, processor 106 can execute instructions 116 to identify the catheter locations 124a and imaging catheter tip by inferring the locations using an ML model (refer to FIG. 6A and FIG. 6B). With some embodiments, processor 106 can execute instructions 116 to infer locations of guide catheter entry for several frames of angiography image frames 118 and select the frame where a guide catheter entry is identified with the highest confidence as the initial angiography image frame 122. In further examples, processor 106 can execute instructions 116 to identify the imaging catheter tip location and the guide catheter entry point location using different ML models (e.g., refer to FIG. 6A).

Continuing to block 306 “identify, by the computing device, a centerline of the vessel in the first frame based in part on the locations of the catheter” a centerline of the vessel can be identified from the first frame and the catheter locations. For example, computing device 104 can be configured to identify vessel centerline 126b from catheter locations 124a and initial angiography image frame 122. Processor 106 can execute instructions 116 to identify, based on a centerline mapping algorithm, the vessel centerline 126a from catheter locations 124a and initial angiography image frame 122.

Continuing to block 308 “identify, by the computing device, side branches of the vessel based in part on the centerline” side branches of the vessel can be identified based on the vessel centerline. For example, computing device 104 can be configured to identify angiography image side branch locations 128a from vessel centerline 126a and initial angiography image frame 122.

FIG. 4 illustrates routines 400, which can begin at block 402. At block 402 “track, by the computing device, locations of key points in a subsequent (N>1) frame of the angiography image frames based on locations of key points in the prior (N−1) frame of the angiography image frames” key points can be tracked between (or across) multiple angiography image frames. For example, computing device 104 can be configured to track key points 138a from initial angiography image frame 122 to subsequent angiography image frame 136, thereby identifying key points 138b. Processor 106 can execute instructions 116 to track or identify key points 138b from subsequent angiography image frame 136 based on key points 138a and initial angiography image frame 122.

Continuing to block 404 “identify, by the computing device, a centerline of the vessel in the subsequent frame based in part on the locations of key points” a centerline of the vessel can be generated from the subsequent frame and the key point locations. For example, computing device 104 can be configured to identify vessel centerline 126b from key points 138b and subsequent angiography image frame 136. Processor 106 can execute instructions 116 to identify, based on a centerline mapping algorithm, the vessel centerline 126b from key points 138b and subsequent angiography image frame 136.

FIG. 5 illustrates routines 500, which can begin at block 502. At block 502 “receive, at the computing device, IVUS image frames of the vessel of the patient” IVUS image frames can be received at the computing device. For example, computing device 104 of live co-registration system 100 can receive IVUS image frames 120. With some embodiments, IVUS image frames 120 can be received from vascular imaging system 102 while in other embodiments IVUS image frames 120 can have been previously captured by vascular imaging system 102 and stored in memory (e.g., memory 108, a memory location accessible over network interface 114). Said differently, with some examples, live co-registration system 100 can be configured to co-register angiography image frames 118 with IVUS image frames 120 in real-time while both angiography image frames 118 and IVUS image frames 120 are captured; while in other embodiments live co-registration system 100 can be configured to co-register angiography image frames 118 with IVUS image frames 120 while angiography image frames 118 is being captured where IVUS image frames 120 has been previously captured. In some embodiments, live co-registration system 100 can be configured to co-register angiography image frames 118 with IVUS image frames 120 while IVUS image frames 120 are being captured where angiography image frames 118 have been previously captured. With still other embodiments, live co-registration system 100 can be configured to co-register angiography image frames 118 with IVUS image frames 120 where both angiography image frames 118 and IVUS image frames 120 have been previously captured.

Continuing to block 504 “identify, by the computing device, side branches in the IVUS image frames” side branches in the IVUS image frames can be identified. For example, computing device 104 can be configured to identify IVUS images side branch locations 130 from IVUS image frames 120. Processor 106 can execute instructions 116 to identify IVUS images side branch locations 130 from IVUS image frames 120 using any of a variety of side branch identification techniques.

Continuing to block 506 “map, by the computing device, the IVUS side branches onto a frame (N≥1) of the angiography image frames based in part on the vessel centerline of the frame” locations of the IVUS side branches can be mapped onto a frame of the angiography images. For example, computing device 104 can be configured to map IVUS images side branch locations 130 onto a frame of angiography image frames 118 based on the vessel centerline of the frame. As a specific example, processor 106 can execute instructions 116 to map IVUS images side branch locations 130 onto initial angiography image frame 122 based in part on vessel centerline 126a, resulting in mapped side branches 132a. As another specific example, processor 106 can execute instructions 116 to map IVUS images side branch locations 130 onto subsequent angiography image frame 136 based in part on vessel centerline 126b, resulting in mapped side branches 132b. It is noted, processor 106 can execute instructions 116 to map all frames from IVUS image frames 120 onto the angiography image frame 118 where the mapping of the IVUS images side branch locations 130 act as control points to align the angiography and IVUS side branches and minimize effects of foreshortening.

Continuing to block 508 “match, by the computing device, IVUS side branches and angiography side branches with each other” the IVUS side branches mapped onto the angiography image and the angiography image side branches can be matched to each other. For example, computing device 104 can be configured to match angiography image side branch locations 128a and IVUS images side branch locations 130 based on mapped side branches 132a. As a specific example, processor 106 can execute instructions 116 to match angiography image side branch locations 128a with IVUS images side branch locations 130 based on mapped side branches 132a, resulting in matched side branches 134a. As another specific example, processor 106 can execute instructions 116 to match angiography image side branch locations 128b with IVUS images side branch locations 130 based on mapped side branches 132b, resulting in matched side branches 134b.

Continuing to block 510 “adjust, by the computing device, IVUS side branch locations based on the matching” locations of the IVUS side branches can be adjusted based on the matching between the angiography image side branches and the IVUS image side branches. For example, computing device 104 can be configured to adjust the location of the IVUS image side branches 130 based on the matching between the angiography image side branch locations 128a and IVUS images side branch locations 130 at block 508.

FIG. 6A and FIG. 6B illustrate examples of identifying guide catheter locations and a vessel centerline, according to some embodiments. These figures are depicted with reference to live co-registration system 100 and initial angiography image frame 122. However, FIG. 6A and FIG. 6B could be implemented to identify guide catheter locations from another one of angiography image frames 118 (e.g., subsequent angiography image frame 136, or the like).

FIG. 6A illustrates an ML model 602 comprising an entry identification model 604a and an entry identification model 604b. In general, ML model 602 can be configured to infer catheter locations 124a from initial angiography image frame 122. For example, entry identification model 604a can be configured to infer a tip of an imaging catheter from an angiography image (e.g., initial angiography image frame 122) while entry identification model 604b can be configured to infer an entry point of the guide catheter from an angiography image.

As noted above, in some embodiments, an imaging catheter tip may not be identifiable from an angiography image or may be identified with a confidence below a threshold level. In such examples, an indication of the location of the imaging catheter tip for initial angiography image frame 122 can be received by the computing device 104 from a user of the live co-registration system 100.

FIG. 6B illustrates subroutine block 606, which can be a subroutine of instructions 116 of live co-registration system 100 configured to identify a centerline (e.g., centerline identification algorithm, or the like). That is, instructions 116 can comprise subroutine block 606, which itself is executable by processor 106 to identify a vessel centerline (e.g., vessel centerline 126a, or the like). For example, FIG. 6B illustrates subroutine block 606 configured to identify vessel centerline 126a on initial angiography image frame 122 from initial angiography image frame 122, catheter locations 124a (e.g., entry point location 608, and imaging tip location 610).

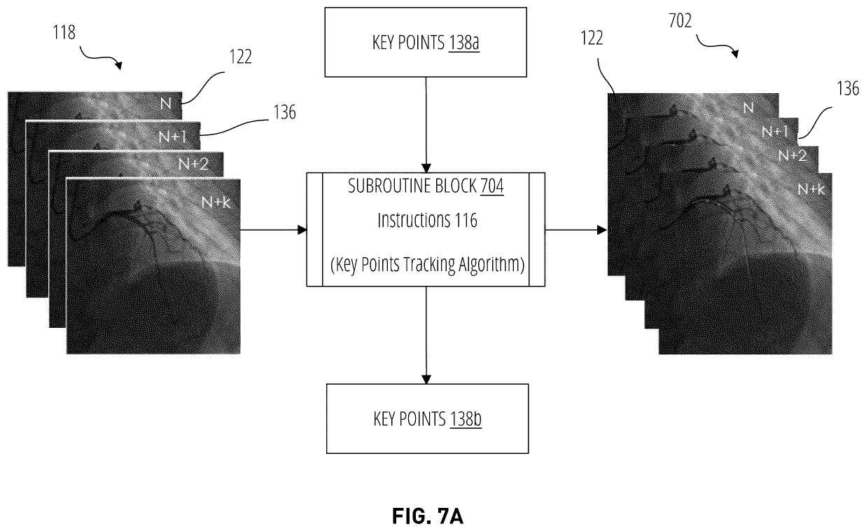

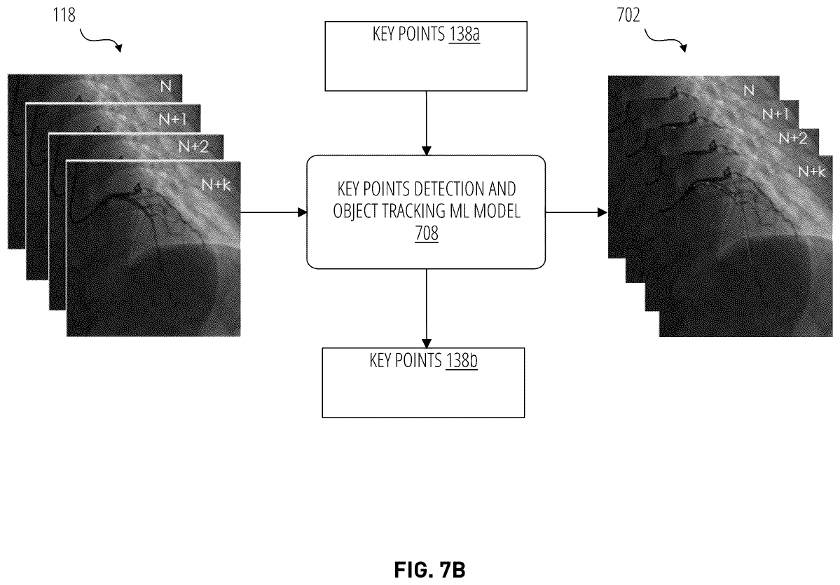

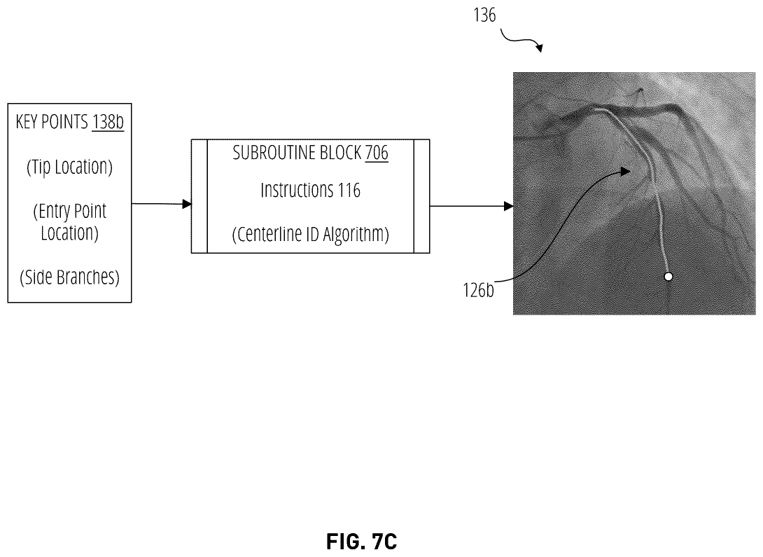

FIG. 7A, FIG. 7B, and FIG. 7C illustrate examples of tracking and/or identifying key points and identifying a vessel centerline from key points, according to some embodiments. These figures are depicted with reference to live co-registration system 100 and angiography image frames 118. For example, these figures depict tracking key points in angiography image frames 118 to identify angiography images with key points 702.

FIG. 7A illustrates subroutine block 704, which can be a subroutine of instructions 116 of live co-registration system 100 configured to track key points in angiography image frames (e.g., key points tracking algorithm, or the like). That is, instructions 116 can comprise subroutine block 704, which itself is executable by processor 106 to track key points across angiography image frames 118 to identify angiography images with key points 702. As noted above key points can include guide catheter entry location, and imaging catheter tip (as well as side branch locations. For example, FIG. 7A illustrates subroutine block 704 configured to identify track key points between initial angiography image frame 122 and subsequent angiography image frame 136 based on key points 138a, resulting in key points 138b being identified.

FIG. 7B illustrates a key points detection and object tracking ML model 708. In general, key points detection and object tracking ML model 708 can be configured to infer key points 138b from matched side branches 134a and angiography image frames 118. Processor 106 can be configured to execute instructions 116 to infer key points 138b from key points 138a based on key points detection and object tracking ML model 708 and angiography image frames 118.

FIG. 7C illustrates subroutine block 706, which can be a subroutine of instructions 116 of live co-registration system 100 configured to identify a centerline from key points in angiography image frames (e.g., key centerline identification algorithm, or the like). That is, instructions 116 can comprise subroutine block 706, which itself is executable by processor 106 to identify a vessel centerline (e.g., vessel centerline 126b, or the like). For example, FIG. 7C illustrates subroutine block 706 configured to identify vessel centerline 126b on subsequent angiography image frame 136 from subsequent angiography image frame 136 and key points 138b.

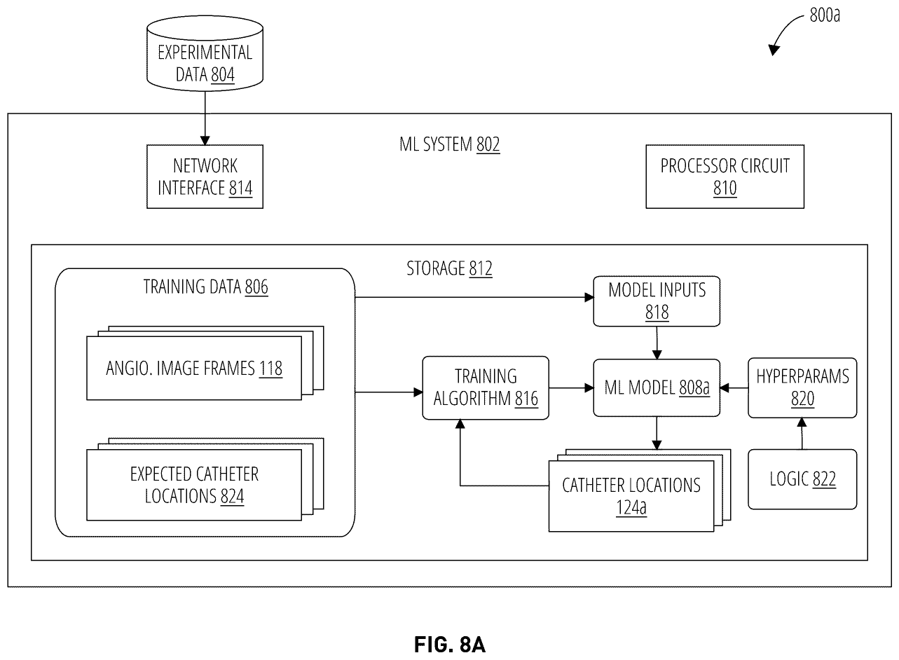

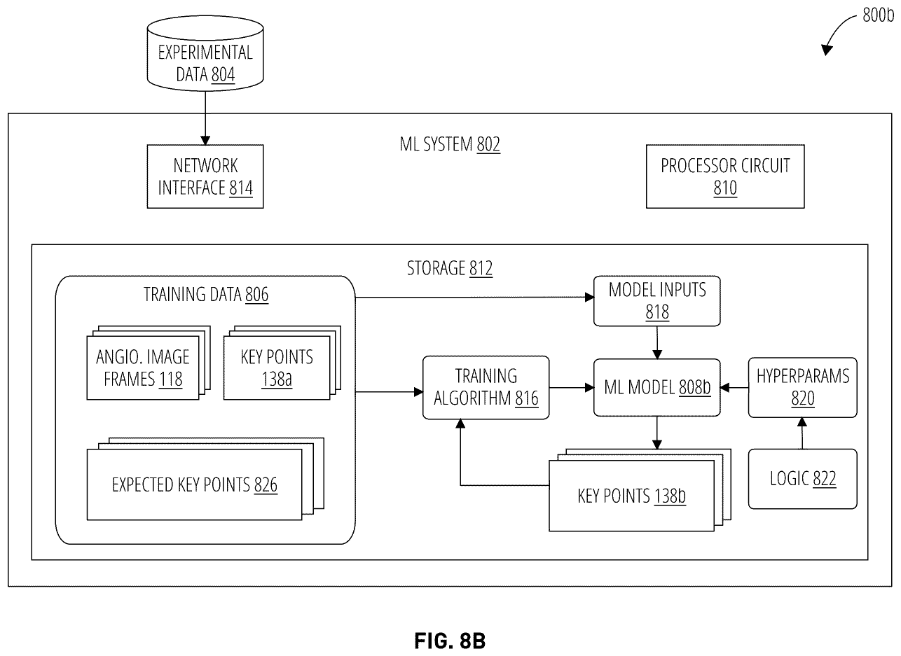

As noted, with some embodiments, an ML model can be utilized to infer guide catheter locations and/or key points in an angiography image. For example, processor 106 of computing device 104 can execute instructions 116 to infer catheter locations 124a from angiography image frames 118 using ML models 602 or to infer key points 138a, 138b, etc., from angiography image frames 118 using key points detection and object tracking ML model 708. In such examples, the ML models can be stored in memory 108 of computing device 104. It will be appreciated however, that prior to being deployed, the ML models are to be trained. FIG. 8A illustrates ML training environment 800a, which can be used to train an ML model that may later be used to generate (or infer) catheter locations 124a, 124b, etc., from angiography image frames 118 as described herein. The ML training environment 800a may include an ML system 802, such as a computing device that applies an ML algorithm to learn relationships. In this example, the ML algorithm can learn relationships between a set of inputs (e.g., angiography image frames 118) and an output (e.g., catheter locations 124a, 124b, etc.)

The ML system 802 may make use of experimental data 804 gathered during several prior procedures. Experimental data 804 can include angiography image frames 118 for several patients. The experimental data 804 may be collocated with the ML system 802 (e.g., stored in a storage 812 of the ML system 802), may be remote from the ML system 802 and accessed via a network interface 814, or may be a combination of local and remote data.

Experimental data 804 can be used to form training data 806, which includes the angiography image frames 118 (e.g., initial angiography image frame 122, subsequent angiography image frame 136, etc.).

As noted above, the ML System 802 may include a storage 812, which may include a hard drive, solid state storage, and/or random access memory. The storage 812 may hold training data 806. In general, training data 806 can include information elements or data structures comprising indications of angiography image frames 118 and associated expected catheter locations 824. The training data 806 may be applied to train an ML model 808a. Depending on the application, different types of models may be used to form the basis of ML model 808a. For instance, in the present example, an artificial neural network (ANN) may be particularly well-suited to learning associations between CT angiography images and/or IVUS images (e.g., angiography image frames 118, or the like) and catheter locations 124a, 124b, etc. (e.g., indications of locations of the imaging catheter tip and/or guide catheter entry point) in angiography image frames 118. Convoluted neural networks may also be well-suited to this task. Any suitable training algorithm 816 may be used to train the ML model 808a. Nonetheless, the example depicted in FIG. 8A may be particularly well-suited to a supervised training algorithm or reinforcement learning training algorithm. For a supervised training algorithm, the ML System 802 may apply the angiography image frames 118 as model inputs 818, to which expected catheter locations 824 may be mapped to learn associations between the angiography image frames 118 and the catheter locations 124a, 124b etc. In a reinforcement learning scenario, training algorithm 816 may attempt to maximize some or all (or a weighted combination) of the model inputs 818 mappings to catheter locations 124a, 124b, etc., to produce ML model 808a having the least error. With some embodiments, training data 806 can be split into “training” and “testing” data wherein some subset of the training data 806 can be used to adjust the ML model 808a (e.g., internal weights of the model, or the like) while another, non-overlapping subset of the training data 806 can be used to measure an accuracy of the ML model 808a to infer (or generalize) guide catheter locations from “unseen” training data 806 (e.g., training data 806 not used to train ML model 808a).

The ML model 808a may be applied using a processor circuit 810, which may include suitable hardware processing resources that operate on the logic and structures in the storage 812. The training algorithm 816 and/or the development of the trained ML model 808a may be at least partially dependent on hyperparameters 820. In exemplary embodiments, the model hyperparameters 820 may be automatically selected based on hyperparameter optimization logic 822, which may include any known hyperparameter optimization techniques as appropriate to the ML model 808a selected and the training algorithm 816 to be used. In optional, embodiments, the ML model 808a may be re-trained over time, to accommodate new knowledge and/or updated experimental data 804.

Once the ML model 808a is trained, it may be applied (e.g., by the processor circuit 810, by processor 106, or the like) to new input data (e.g., angiography image frames 118 captured during a pre-PCI intervention, a post-PCI intervention, or the like). This input to the ML model 808a may be formatted according to a predefined model inputs 818 mirroring the way that the training data 806 was provided to the ML model 808a. Trained model ML model 808a may generate catheter locations 124a, 124b, etc., from angiography image frames 118. As noted, ML model 602 can include multiple models. As such, multiple ML model 808a can be trained as outlined above to identify the guide catheter location(s).

ML System 802 can further be utilized to train a model to infer key points for a frame of angiography image frames 118 and key points associated with a prior frame of angiography image frames 118. FIG. 8B illustrates ML training environment 800b, which is an example of ML training environment 800a configured to train ML model 808b to infer key points 138b from angiography image frames 118 and key points 138a. As such, training data 806 can include angiography image frames 118 and key points 138a, 138b, while ML model 808b can be “trained” as outlined above to infer key points 138b from a frame of angiography image frames 118 and key points 138a. Trained ML model 808b may generate key points 138a, 138b, etc., from a frame of angiography image frames 118 and key points from the prior frame.

The above descriptions pertain to a particular kind of ML System 802, which applies supervised learning techniques given available training data with input/result pairs. However, the present invention is not limited to use with a specific ML paradigm, and other types of ML techniques may be used. For example, in some embodiments the ML System 802 may apply for example, evolutionary algorithms, or other types of ML algorithms and models to generate key points as described above.

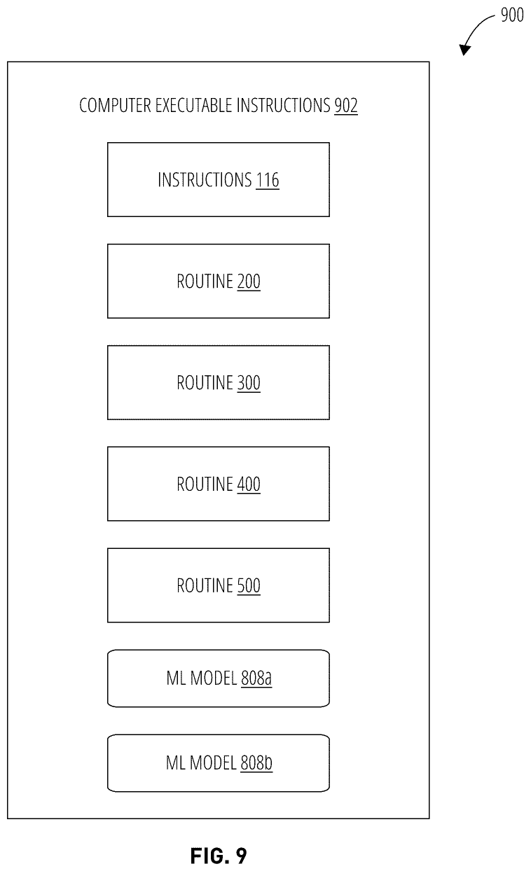

FIG. 9 illustrates computer-readable storage medium 900. Computer-readable storage medium 900 may comprise any non-transitory computer-readable storage medium or machine-readable storage medium, such as an optical, magnetic or semiconductor storage medium. In various embodiments, computer-readable storage medium 900 may comprise an article of manufacture. In some embodiments, computer-readable storage medium 900 may store computer executable instructions 902 with which circuitry (e.g., processor 106, or the like) can execute. For example, computer executable instructions 902 can include instructions to implement operations described with respect live co-registration system 100, which can improve the functioning of live co-registration system 100 as detailed herein. For example, computer executable instructions 902 can include instructions that can cause a computing device to implemented routine 200 of FIG. 2, routine 300 of FIG. 3, routine 400 of FIG. 4, routine 500 of FIG. 5. As another example, computer executable instructions 902 can include instructions 116, ML model 808a, and/or ML model 808b. Examples of computer-readable storage medium 900 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 902 may include any suitable type of code, such as source code, compiled code, interpreted code, executable code, static code, dynamic code, object-oriented code, visual code, and the like.

FIG. 10 illustrates a combined internal and external imaging system 1000 including both an endoluminal imaging system 1002 (e.g., an IVUS imaging system, or the like) and an extravascular imaging system 1004 (e.g., an angiographic imaging system). Combined internal and external imaging system 1000 further includes computing device 1006, which includes circuitry, controllers, and/or processor(s) and memory and software as needed. With some embodiments, live co-registration system 100 can be incorporated into computing device 1006 or live co-registration system 100 can incorporate computing device 1006. In general, the endoluminal imaging system 1002 can be arranged to generate intravascular imaging data (e.g., IVUS images, or the like) while the extravascular imaging system 1004 can be arranged to generate extravascular imaging data (e.g., angiography images, or the like).

The extravascular imaging system 1004 may include a table 1008 that may be arranged to provide sufficient space for the positioning of an angiography/fluoroscopy unit c-arm 1010 in an operative position in relation to a patient 1012 on the drive unit. C-arm 1010 can be configured to acquires fluoroscopic images in the absence of contrast agent in the blood vessels of the patient 1012 and/or acquire angiographic image while there is a presence of contrast agent in the blood vessels of the patient 1012.

Raw radiological image data acquired by the c-arm 1010 may be passed to an extravascular data input port 1014 via a transmission cable 1016. The input port 1014 may be a separate component or may be integrated into or be part of the computing device 1006. The input port 1014 may include a processor that converts the raw radiological image data received thereby into extravascular image data (e.g., angiographic/fluoroscopic image data), for example, in the form of live video, DICOM, or a series of individual images. The extravascular image data may be initially stored in memory within the input port 1014 or may be stored within memory of computing device 1006. If the input port 1014 is a separate component from the computing device 1006, the extravascular image data may be transferred to the computing device 1006 through the transmission cable 1016 and into an input port (not shown) of the computing device 1006. In some alternatives, the communications between the devices or processors may be carried out via wireless communication, rather than by cables as depicted.

The intravascular imaging data may be, for example, IVUS data or OCT data obtained by the endoluminal imaging system 1002. The endoluminal imaging system 1002 may include an intravascular imaging device such as an imaging catheter 1020. The imaging catheter 1020 is configured to be inserted within the patient 1012 so that its distal end, including a diagnostic assembly or probe 1022 (e.g., an IVUS probe), is in the vicinity of a desired imaging location of a blood vessel. A radiopaque material or marker 1024 located on or near the probe 1022 may provide indicia of a current location of the probe 1022 in a radiological image. In some embodiments, imaging catheter 1020 and/or probe 1022 can include a guide catheter (not shown) that has been inserted into a lumen of the subject (e.g., a blood vessel, such as a coronary artery) over a guidewire (also not shown). However, in some embodiments, the imaging catheter 1020 and/or probe 1022 can be inserted into the vessel of the patient 1012 without a guidewire.

With some embodiments, imaging catheter 1020 and/or probe 1022 can include both imaging capabilities as well as other data-acquisition capabilities. For example, FFR and/or iFR data, data related to pressure, flow, temperature, electrical activity, oxygenation, biochemical composition, or any combination thereof. In some embodiments, imaging catheter 1020 and/or probe 1022 can further include a therapeutic device, such as a stent, a balloon (e.g., an angioplasty balloon), a graft, a filter, a valve, and/or a different type of therapeutic endoluminal device.

Imaging catheter 1020 is coupled to a proximal connector 1026 to couple imaging catheter 1020 to image acquisition device 1028. Image acquisition device 1028 may be coupled to computing device 1006 via transmission cable 1016, or a wireless connection. The intravascular image data may be initially stored in memory within the image acquisition device 1028 or may be stored within memory of computing device 1006. If the image acquisition device 1028 is a separate component from computing device 1006, the intravascular image data may be transferred to the computing device 1006, via, for example, transmission cable 1016.

The computing device 1006 can also include one or more additional output ports for transferring data to other devices. For example, the computer can include an output port to transfer data to a data archive or memory device 1032. The computing device 1006 can also include a user interface (described in greater detail below) that includes a combination of circuitry, processing components and instructions executable by the processing components and/or circuitry to enable the image identification and vessel routing or pathfinding described herein and/or dynamic co-registration of intravascular and extravascular images using the identified vessel pathway.

In some embodiments, computing device 1006 can include user interface devices, such as, a keyboard, a mouse, a joystick, a touchscreen device (such as a smartphone or a tablet computer), a touchpad, a trackball, a voice-command interface, and/or other types of user interfaces that are known in the art.

The user interface can be rendered and displayed on display 1034 coupled to computing device 1006 via display cable 1036. Although the display 1034 is depicted as separate from computing device 1006, in some examples the display 1034 can be part of computing device 1006. Alternatively, the display 1034 can be remote and wireless from computing device 1006. As another example, the display 1034 can be part of another computing device different from computing device 1006, such as, a tablet computer, which can be coupled to computing device 1006 via a wired or wireless connection. For some applications, the display 1034 includes a head-up display and/or a head-mounted display. For some applications, the computing device 1006 generates an output on a different type of visual, text, graphics, tactile, audio, and/or video output device, e.g., speakers, headphones, a smartphone, or a tablet computer. For some applications, the user interface rendered on display 1034 acts as both an input device and an output device.

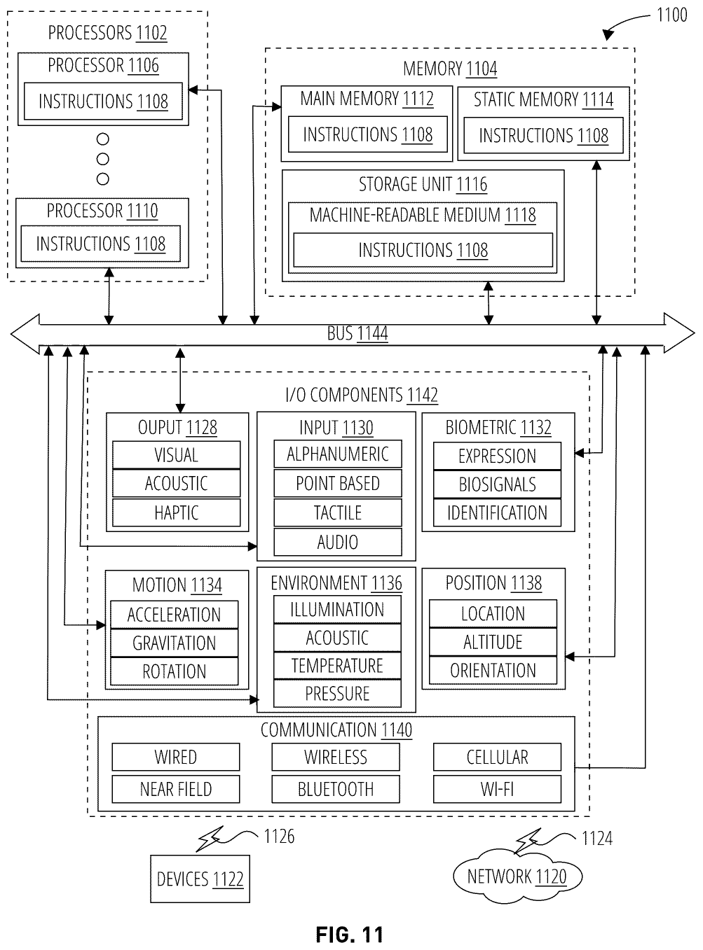

FIG. 11 illustrates a diagrammatic representation of a machine 1100 in the form of a computer system within which a set of instructions may be executed for causing the machine to perform any one or more of the methodologies discussed herein. More specifically, FIG. 11 shows a diagrammatic representation of the machine 1100 in the example form of a computer system, within which instructions 1108 (e.g., software, a program, an application, an applet, an app, or other executable code) for causing the machine 1100 to perform any one or more of the methodologies discussed herein may be executed. For example, the instructions 1108 may cause the machine 1100 to execute instructions 116, routine 200 of FIG. 2, routine 300 of FIG. 3, routine 400 of FIG. 4, routine 500 of FIG. 5, training algorithm 816 of FIG. 8A or FIG. 8B or the like. More generally, the instructions 1108 may cause the machine 1100 to co-register IVUS images with angiography images from a cine-loop in real-time as outlined herein.

The instructions 1108 transform the general, non-programmed machine 1100 into a particular machine 1100 programmed to carry out the described and illustrated functions in a specific manner. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1108, sequentially or otherwise, that specify actions to be taken by the machine 1100. Further, while only a single machine 1100 is illustrated, the term “machine” shall also be taken to include a collection of machines 200 that individually or jointly execute the instructions 1108 to perform any one or more of the methodologies discussed herein.

The machine 1100 may include processors 1102, memory 1104, and I/O components 1142, which may be configured to communicate with each other such as via a bus 1144. In an example embodiment, the processors 1102 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1106 and a processor 1110 that may execute the instructions 1108. The term “processor” is intended to include multi-core processors that may comprise two or more independent processors (sometimes referred to as “cores”) that may execute instructions contemporaneously. Although FIG. 11 shows multiple processors 1102, the machine 1100 may include a single processor with a single core, a single processor with multiple cores (e.g., a multi-core processor), multiple processors with a single core, multiple processors with multiples cores, or any combination thereof.

The memory 1104 may include a main memory 1112, a static memory 1114, and a storage unit 1116, both accessible to the processors 1102 such as via the bus 1144. The main memory 1104, the static memory 1114, and storage unit 1116 store the instructions 1108 embodying any one or more of the methodologies or functions described herein. The instructions 1108 may also reside, completely or partially, within the main memory 1112, within the static memory 1114, within machine-readable medium 1118 within the storage unit 1116, within at least one of the processors 1102 (e.g., within the processor's cache memory), or any suitable combination thereof, during execution thereof by the machine 1100.

The I/O components 1142 may include a wide variety of components to receive input, provide output, produce output, transmit information, exchange information, capture measurements, and so on. The specific I/O components 1142 that are included in a particular machine will depend on the type of machine. For example, portable machines such as mobile phones will likely include a touch input device or other such input mechanisms, while a headless server machine will likely not include such a touch input device. It will be appreciated that the I/O components 1142 may include many other components that are not shown in FIG. 11. The I/O components 1142 are grouped according to functionality merely for simplifying the following discussion and the grouping is in no way limiting. In various example embodiments, the I/O components 1142 may include output components 1128 and input components 1130. The output components 1128 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1130 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1142 may include biometric components 1132, motion components 1134, environmental components 1136, or position components 1138, among a wide array of other components. For example, the biometric components 1132 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1134 may include acceleration sensor components (e.g., accelerometer), gravitation sensor components, rotation sensor components (e.g., gyroscope), and so forth. The environmental components 1136 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1142 may include communication components 1140 operable to couple the machine 1100 to a network 1120 or devices 1122 via a coupling 1124 and a coupling 1126, respectively. For example, the communication components 1140 may include a network interface component or another suitable device to interface with the network 1120. In further examples, the communication components 1140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1122 may be another machine or any of a wide variety of peripheral devices (e.g., a peripheral device coupled via a USB).

Moreover, the communication components 1140 may detect identifiers or include components operable to detect identifiers. For example, the communication components 1140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as location via Internet Protocol (IP) geolocation, location via Wi-Fi® signal triangulation, location via detecting an NFC beacon signal that may indicate a particular location, and so forth.

The various memories (i.e., memory 1104, main memory 1112, static memory 1114, and/or memory of the processors 1102) and/or storage unit 1116 may store one or more sets of instructions and data structures (e.g., software) embodying or utilized by any one or more of the methodologies or functions described herein. These instructions (e.g., the instructions 1108), when executed by processors 1102, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1120 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1120 or a portion of the network 1120 may include a wireless or cellular network, and the coupling 1124 may be a Code Division Multiple Access (CDMA) connection, a Global System for Mobile communications (GSM) connection, or another type of cellular or wireless coupling. In this example, the coupling 1124 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1108 may be transmitted or received over the network 1120 using a transmission medium via a network interface device (e.g., a network interface component included in the communication components 1140) and utilizing any one of several well-known transfer protocols (e.g., hypertext transfer protocol (HTTP)). Similarly, the instructions 1108 may be transmitted or received using a transmission medium via the coupling 1126 (e.g., a peer-to-peer coupling) to the devices 1122. The terms “transmission medium” and “signal medium” mean the same thing and may be used interchangeably in this disclosure. The terms “transmission medium” and “signal medium” shall be taken to include any intangible medium that can store, encoding, or carrying the instructions 1108 for execution by the machine 1100, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

What is claimed is:

1. An apparatus for a cross-modality side branch matching system, the apparatus, comprising:
a processor and a memory storage device coupled to the processor, the memory storage device comprising instructions executable by the processor, which instructions when executed cause the apparatus to:
receive a plurality of extravascular image frames associated with a vessel of a patient;
identify locations of key points in a first frame of the plurality extravascular image frames;
identify locations of the key points in a second frame of the plurality of extravascular image frames based in part on the locations of the key points in the first frame; and
co-register a plurality of intravascular image frames with the first frame based in part on the locations of the key points in the first frame; or
co-register the plurality of intravascular image frames with the second frame based in part on the locations of the key points in the second frame; or
co-register a plurality of intravascular image frames with the first frame based in part on the locations of the key points in the first frame and co-registering the plurality of intravascular image frames with the second frame based in part on the locations of the key points in the second frame.

2. The apparatus of claim 1, the instructions when executed further cause the apparatus to:
generate a first graphical indication of the first frame co-registered with the plurality of intravascular image frames and a second graphical indication of the second frame co-registered with the plurality of intravascular image frames; and
send the first graphical indication and the second graphical indication to a display device to display the co-registered plurality of intravascular images in synchronization with a cardiac motion associated with the plurality of extravascular image frames.

3. The apparatus method of claim 1, wherein the plurality of image frames are image frames from a cine loop captured during a fluoroscopy procedure.

4. The apparatus of claim 1, wherein the plurality of intravascular image frames are intravascular ultrasound (IVUS) image frames.

5. The apparatus of claims 1, the instructions when executed further cause the apparatus to:
receive an additional extravascular image frame;
identify locations of the key points in the additional extravascular frame based in part on the locations of the key points in the second frame; and
co-register the plurality of intravascular image frames with the additional extravascular image frame based in part on the locations of the key points in the additional extravascular image frame.

6. The apparatus of claim 5, the instructions when executed to receive the additional extravascular image frame further causes the apparatus to receive the additional extravascular image frame during an extravascular imaging procedure.

7. The apparatus of claim 6, the instructions when executed to identify the locations of the key points in the first frame further causes the apparatus to:
identify catheter locations in the first frame;
identify a centerline of the vessel in the first frame based in part on the at catheter locations; and
identify locations of side branches of the vessel along the centerline.

8. The apparatus of claim 6, the instructions when executed to identify the catheter locations in the first frame further causes the apparatus to:
infer, using a tip identification machine learning (ML) model, a location of a tip of an imaging catheter in the first frame; or
receive, from an input device coupled to the computing device, an indication of the location of the tip of the imaging catheter in the first frame.

9. The apparatus of claim 8, the instructions when executed to identify the catheter locations in the first frame further causes the apparatus to infer, using an entry point identification ML model, a location of an entry point of the guide catheter in the first frame.

10. The apparatus of claim 9, the instructions when executed to co-register the plurality of intravascular image frames with the first frame based in part on the locations of the key points in the first frame further causes the apparatus to:
receive the plurality of intravascular image frames;
identify a subset of frames of the plurality of intravascular image frames associated with a side branch;
map the plurality of intravascular image frames onto the centerline based in part on the subset of frames of the plurality of intravascular image frames associated with the side branch;
match the side branches associated with the first frame with the side branches associated with the subset of frames of the plurality of intravascular image frames; and
adjust locations of the side branches associated with the subset of frames based in part on the matching.

11. The apparatus of claim 9, the instructions when executed to identify the locations of the key points in the second frame of the plurality of extravascular image frames based in part on the locations of the key points in the first frame further causes the apparatus to:
track the catheter locations between the first frame and the second frame;
track the locations of the side branches of the vessel between the first frame and the second frame; and
identify the centerline of the vessel in the second frame based in part on the locations of the tip of the guide catheter, the entry point of the guide catheter, and the side branches.

12. The apparatus of claim 9, the instructions when executed to identify the locations of the key points in the first frame further causes the apparatus to:
infer using the tip identification ML model, a location of the tip of the guide catheter in each of the plurality of extravascular image frames, wherein a confidence value, for each inference of the location of the tip of the guide catheter, is output from the tip identification ML model;
select the first frame as the one of the plurality of extravascular image frames associated with the highest confidence value.

13. The apparatus of claim 9, the instructions when executed to identify the locations of the key points in the first frame further causes the apparatus to:
identify a contrast for each of the plurality of extravascular image frames; and
select the first frame as the one of the plurality of extravascular image frames having the viable image quality.

14. A computer-readable storage device, comprising instructions executable by a processor of a cross-modality side branch matching system, wherein when executed the instructions cause the processor to:
receive a plurality of extravascular image frames associated with a vessel of a patient;
identify locations of key points in a first frame of the plurality extravascular image frames;
identify locations of the key points in a second frame of the plurality of extravascular image frames based in part on the locations of the key points in the first frame; and
co-register a plurality of intravascular image frames with the first frame based in part on the locations of the key points in the first frame; or
co-register the plurality of intravascular image frames with the second frame based in part on the locations of the key points in the second frame; or
co-register a plurality of intravascular image frames with the first frame based in part on the locations of the key points in the first frame and co-registering the plurality of intravascular image frames with the second frame based in part on the locations of the key points in the second frame.

15. The computer-readable storage device of claim 14, the instructions when executed further cause the processor to:
generate a first graphical indication of the first frame co-registered with the plurality of intravascular image frames and a second graphical indication of the second frame co-registered with the plurality of intravascular image frames; and
send the first graphical indication and the second graphical indication to a display device to display the co-registered plurality of intravascular images in synchronization with a cardiac motion associated with the plurality of extravascular image frames.

16. The computer-readable storage device method of claim 14, wherein the plurality of image frames are image frames from a cine loop captured during a fluoroscopy procedure.

17. The computer-readable storage device of claim 14, wherein the plurality of intravascular image frames are intravascular ultrasound (IVUS) image frames.

18. The computer-readable storage device of claims 14, the instructions when executed further cause the processor to:
receive an additional extravascular image frame;
identify locations of the key points in the additional extravascular frame based in part on the locations of the key points in the second frame; and
co-register the plurality of intravascular image frames with the additional extravascular image frame based in part on the locations of the key points in the additional extravascular image frame.

19. A method for identifying side branches from an image, comprising:
receiving, at a computing device, a plurality of extravascular image frames associated with a vessel of a patient;
identifying, by the computing device, locations of key points in a first frame of the plurality extravascular image frames;
identifying, by the computing device, locations of the key points in a second frame of the plurality of extravascular image frames based in part on the locations of the key points in the first frame; and
co-registering a plurality of intravascular image frames with the first frame based in part on the locations of the key points in the first frame; or
co-registering the plurality of intravascular image frames with the second frame based in part on the locations of the key points in the second frame; or
co-registering a plurality of intravascular image frames with the first frame based in part on the locations of the key points in the first frame and co-registering the plurality of intravascular image frames with the second frame based in part on the locations of the key points in the second frame.

20. The method of claim 19, further comprising:
generating, by the computing device, a first graphical indication of the first frame co-registered with the plurality of intravascular image frames and a second graphical indication of the second frame co-registered with the plurality of intravascular image frames; and
sending the first graphical indication and the second graphical indication to a display device to display the co-registered plurality of intravascular images in synchronization with a cardiac motion associated with the plurality of extravascular image frames.
